(19) United States
(12) Patent Application Publication
(10) Pub. No.: US 2026/0121532 A1
(43) Pub. Date: Apr. 30, 2026

(54) BOOTSTRAP CONTROL CIRCUIT AND VOLTAGE CONVERTING DEVICE

(71) Applicant: Novatek Microelectronics Corp., Hsinchu (TW)

(72) Inventors: Tzu-Hsien Yang, Hsinchu County (TW); Yu-Tzu Chao, Kaohsiung City (TW); Tsung-Ying Huang, Hsinchu City (TW)

(73) Assignee: Novatek Microelectronics Corp., Hsinchu (TW)

(21) Appl. No.: 19/017,799

(22) Filed: Jan. 13, 2025

(30) Foreign Application Priority Data
Oct. 30, 2024 (TW) 113141443

(51) Int. Cl. H02M 3/156

(52) U.S. Cl. CPC H02M 3/156

(57) ABSTRACT

Disclosed are a bootstrap control circuit and a voltage converting device. The bootstrap control circuit includes a current mirror, a diode string, a switch, a control voltage generator and a first transistor. The current mirror, based on an input voltage, mirrors a bias current to generate a mirror current. The diode string is coupled between the current mirror and a reference voltage end. The switch has a first end coupled to the diode string, a control end of the switch receives a first control voltage, a second end of the switch provides a second control voltage. The first transistor, based on the input voltage, generates an output voltage according to the second control voltage.

### CROSS-REFERENCE TO RELATED APPLICATION

This application claims the priority benefit of Taiwan application serial no. 113141443, filed on Oct. 30, 2024. The entirety of the above-mentioned patent application is hereby incorporated by reference herein and made a part of this specification.

### BACKGROUND

### Technical Field

The present disclosure relates to a bootstrap control circuit and a voltage converting device, and more particularly to a bootstrap control circuit and a voltage converting device capable of stably maintaining output voltage under high duty ratio operating conditions.

### Description of Related Art

In the technical field of voltage converting devices, it is often necessary to establish a bootstrap control circuit to correspond with the switching operations of the voltage converting device in order to generate the appropriate output voltage. The bootstrap control circuit may provide an output voltage to the high-side driver of the voltage converting device, and serve as the power supply voltage for the high-side driver.

In a known bootstrap control circuit, when the duty ratio of the switching operation of the voltage converting device is greater than a threshold value, the control end of the transistor generating the output voltage in the bootstrap control circuit may, during continuous off periods of the transistor, fail to elevate the voltage on the control end of the transistor to the predetermined target voltage due to insufficient charging time. Alternatively, during continuous on periods of the transistor, the voltage on the control end of the transistor may decrease due to leakage current, resulting in the inability to maintain the voltage value that generates the output voltage in the bootstrap control circuit. This leads to the phenomenon of insufficient output voltage generation, thereby affecting the operational efficiency of the voltage converting device.

### SUMMARY

The present disclosure provides a bootstrap control circuit and a voltage converting apparatus, capable of maintaining stable voltage output under high duty ratio operation conditions.

A bootstrap control circuit of the present disclosure includes a current mirror, a diode string, a switch, a control voltage generator and a first transistor. The current mirror, based on an input voltage, mirrors a bias current to generate a mirror current. The diode string is coupled between the current mirror and a reference voltage end. The switch has a first end coupled to the diode string, a control end of the switch receives a first control voltage, and a second end of the switch provides a second control voltage. A control voltage generator generates the first control voltage corresponding to a voltage on the reference voltage end. The first transistor, based on the input voltage, generates an output voltage according to the second control voltage.

The voltage converting device of the present disclosure includes a first power transistor, a second power transistor, a first driver, a second driver, an inductor, and the aforementioned bootstrap control circuit. The first power transistor and the second power transistor are connected in series between the input voltage and the reference ground voltage, or connected in series between the output voltage and the reference ground voltage. The first driver and the second driver are respectively configured to drive the first power transistor and the second power transistor. The inductor is coupled between the mutual coupling end of the first power transistor and the second power transistor and an output end or an input end of the voltage converting device. The bootstrap control circuit is coupled between the two ends of the first power transistor.

In view of the above, the bootstrap control circuit of the present disclosure consists of a control voltage generator and a switch positioned between the control end of the first transistor and the current mirror. During a first duty cycle, the control voltage generator enables rapid charging of the control end of the first transistor by causing the switch to turn on. Subsequently, during a second duty cycle, the control voltage generator causes the switch to disconnect, thereby preventing leakage at the control end of the first transistor and effectively maintaining the voltage value of the second control voltage. Consequently, even under operating conditions with relatively high duty ratios, the bootstrap control circuit may maintain the accuracy and stability of the output voltage, thereby effectively enhancing the operational efficiency of the voltage converting device.

### BRIEF DESCRIPTION OF THE DRAWINGS

FIG. 1 illustrates a schematic diagram of a bootstrap control circuit according to an embodiment of the present disclosure.

FIG. 2 illustrates a schematic diagram of a bootstrap control circuit according to another embodiment of the present disclosure.

FIG. 3 illustrates an operational waveform diagram of the bootstrap control circuit 200 of the embodiment shown in FIG. 2 of the present disclosure.

FIG. 4 illustrates a schematic diagram of a bootstrap control circuit according to yet another embodiment of the present disclosure.

FIG. 5 illustrates a schematic diagram of a voltage converting device according to an embodiment of the present disclosure.

FIG. 6 illustrates a schematic diagram of a voltage converting device according to still another embodiment of the present disclosure.

### DESCRIPTION OF THE EMBODIMENTS

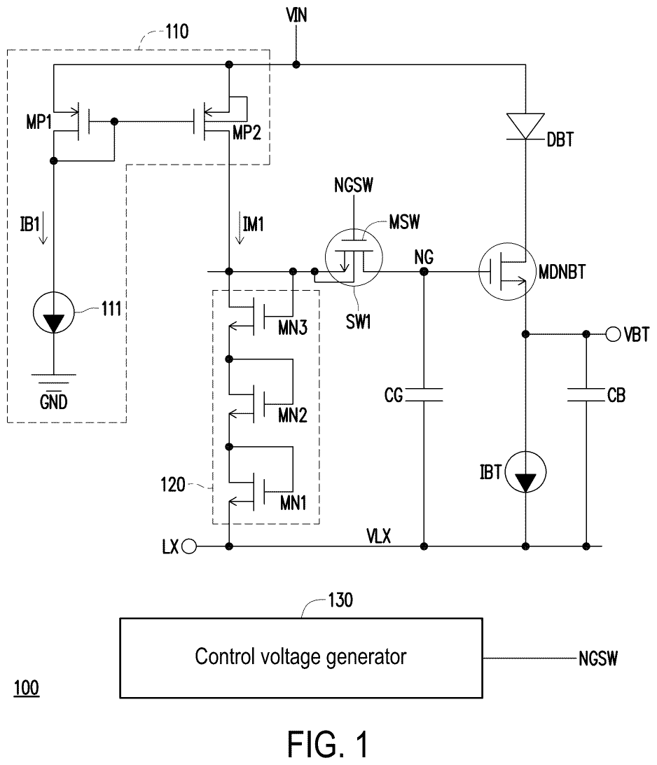

Please refer to FIG. 1, which illustrates a schematic diagram of a bootstrap control circuit according to an embodiment of the present disclosure. The bootstrap control circuit 100 includes a current mirror 110, a diode string 120, a switch SW1, a control voltage generator 130, a transistor MDNBT, a diode DBT, a capacitor CB, and a current source IBT. The current mirror 110, based on the input voltage VIN, is configured to mirror the bias current IB1 to generate the mirror current IM1. The diode string 120 is coupled between the current mirror 110 and the reference voltage end LX. The first end of the switch SW1 is coupled to the diode string 120; the control end of the switch SW1 receives the control voltage NGSW; the second end of the switch SW1 provides the control voltage NG. The first end of the transistor MDNBT receives the input voltage VIN through the diode DBT; the second end of the transistor MDNBT is coupled to the reference voltage end LX through the current source IBT. The capacitor CG is coupled between the control end of the transistor MDNBT and the reference voltage end LX, while the capacitor CB is coupled between the second end of the transistor MDNBT and the reference voltage end LX, serving as a voltage stabilizing capacitor for the output voltage VBT.

The control voltage generator 130 is coupled to the switch SW1, and is configured to generate a control voltage NGSW in response to a reference voltage VLX on the reference voltage end LX. The control voltage NGSW is utilized to control the on or off state of the switch SW1.

The bootstrap control circuit 100 of the present disclosure may be applied in a voltage converting device. The reference voltage end LX may be coupled to an inductor of the voltage converting device. Corresponding to the switching operation of the voltage converting device, the reference voltage VLX may be pulled high or low. During a first duty cycle when the reference voltage VLX is pulled low, the control voltage generator 130 may generate a control voltage NGSW that enables the switch SW1 to turn on, corresponding to the reference voltage VLX which is substantially equal to the reference ground voltage, which allows the mirror current IM1 to pass through the switch SW1 to charge the capacitor CG, thereby raising the voltage value of the control voltage NG. Furthermore, during a second duty cycle when the reference voltage VLX is pulled high, the control voltage generator 130 may generate a control voltage NGSW that causes the switch SW1 to be off, corresponding to the reference voltage VLX which is substantially equal to the input voltage VIN. In this way, it is possible to prevent the capacitor CG from discharging through the switch SW1, thus maintaining the stability of the control voltage NG.

In addition, in the present embodiment, the current mirror 110 includes transistors MP1 and MP2 and a bias current source 111. The transistor MP1 and the bias current source 111 are mutually coupled in series between the input voltage VIN and the reference ground voltage GND. Specifically, the first end of the transistor MP1 receives the input voltage VIN; the second end of the transistor MP1 receives the bias current IB1 generated by the bias current source 111; and the control end of the transistor MP1 is mutually coupled with the second end. The first end of the transistor MP2 receives the input voltage VIN; the second end of the transistor MP2 generates the mirror current IM1; and the control end of the transistor MP2 is coupled to the control end of the transistor MP1. It is noteworthy that the base of the transistor MP2 is coupled to the first end of the transistor MP2.

The diode string 120 includes multiple diodes connected in series. In this embodiment, the diode string 120 includes three diodes constructed respectively by transistors MN1 to MN3 through a diode connection configuration. Specifically, the diodes formed by the transistors MN1 to MN3 are forward-biased between the second end of the transistor MP2 and the reference voltage end LX. It is noteworthy that the number of diodes in the diode string 120 may be adjusted by the designer according to actual requirements. The three diodes illustrated in FIG. 1 are merely exemplary and should not be construed as limiting the scope of implementation of the present disclosure.

Furthermore, the switch SW1 may be a transistor switch. In the present embodiment, the switch SW1 includes a transistor MSW. The first end of the transistor MSW is coupled to the second end of the transistor MP2 in the current mirror 110, and is mutually coupled with the base of the transistor MSW; the second end of the transistor MSW is coupled to the control end of the transistor MDNBT; the control end of the transistor MSW is coupled to the control voltage generator 130 and receives the control voltage NGSW.

In the present embodiment, the transistor MSW may be an N-type transistor, and when the control voltage NGSW is greater than the threshold voltage thereof, the switch SW1 may be turned on. Conversely, when the control voltage NGSW is not greater than the threshold voltage thereof, the switch SW1 may be turned off.

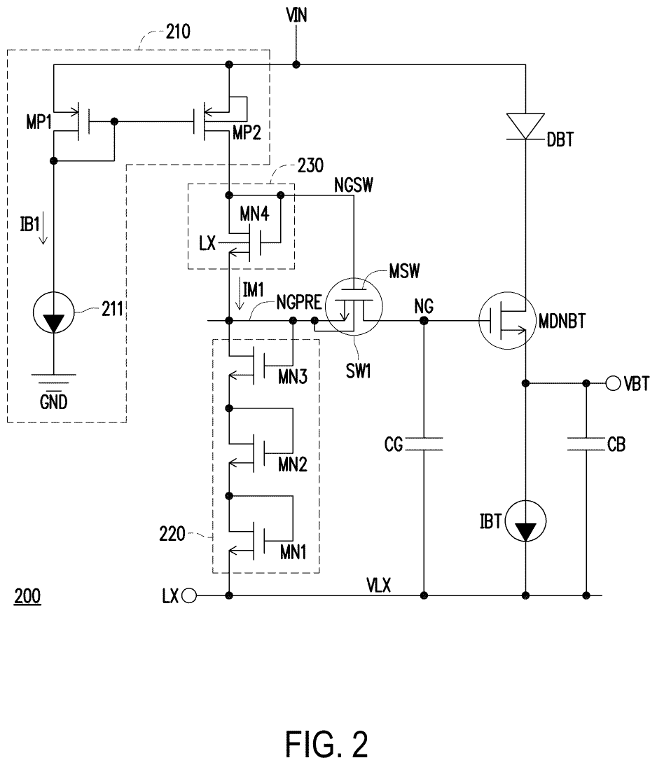

Please refer to FIG. 2, FIG. 2 illustrates a schematic diagram of another embodiment of the bootstrap control circuit of the present disclosure. The bootstrap control circuit 200 includes a current mirror 210, a diode string 220, a control voltage generator 230, a switch SW1, a transistor MDNBT, a diode DBT, a capacitor CB, and a current source IBT. In this embodiment, the current mirror 210 includes a current source 211 and transistors MP1 and MP2. The diode string 220 is coupled to the transistors MN1 to MN3 in series. The current mirror 210 and the diode string 220 have circuit architectures similar to those of the current mirror 110 and the diode string 120 in the embodiment of FIG. 1, respectively, and therefore will not be elaborated upon further herein.

In the present embodiment, the control voltage generator 230 is constructed using the transistor MN4, wherein the first end and the control end of the transistor MN4 are jointly coupled to the transistor MP2 in the current mirror 210; the second end of the transistor MN4 is coupled to the first end of the switch SW1. The first end of the switch SW1 is further coupled to the diode string 220; the second end of the switch SW1 is coupled to the control end of the transistor MDNBT for the purpose of generating the control voltage NG; the control end of the switch SW1 is coupled to the first end of the transistor MN4, and receives the control voltage NGSW. The capacitor CG is coupled between the control end of the transistor MDNBT and the reference voltage end LX; the current source IBT is coupled between the second end of the transistor MDNBT and the reference voltage end LX; the diode DBT is positioned between the first end of the transistor MDNBT and the input voltage VIN.

Similar to the illustrated embodiment in FIG. 1, the switch SW1 is constituted by a transistor MSW. The transistor MSW is an N-type transistor. The first end of the transistor MSW is coupled to the second end of the transistor MP2 in the current mirror 110, and is mutually coupled with the base of the transistor MSW; the second end of the transistor MSW is coupled to the control end of the transistor MDNBT; the control end of the transistor MSW is coupled to the control voltage generator 130, and receives the control voltage NGSW.

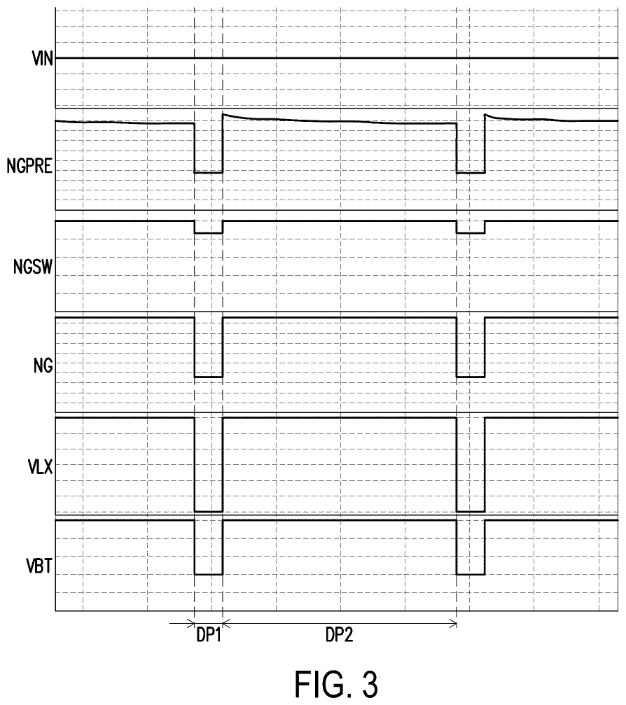

Regarding the operational details of the bootstrap control circuit 200, please refer concurrently to FIG. 2 and FIG. 3, where FIG. 3 illustrates an operational waveform diagram of the bootstrap control circuit 200 of the embodiment shown in FIG. 2 of the present disclosure. In FIG. 3, the horizontal axis represents the time, while the vertical axis represents the voltage.

In the first duty cycle DP1, the reference voltage VLX on the reference voltage end LX is pulled low to substantially equal to the reference ground voltage (e.g., 0 volts) due to the conduction of the low-side power transistor of the voltage converter corresponding to the bootstrap control circuit 500. Concurrently, the current mirror 210 generates a mirror current IM1 by mirroring the bias current IB1. The mirror current IM1 flows through the transistor MN4, consequently generating a control voltage NGSW at the first end of the transistor MN4. For illustrative purposes, assuming an input voltage VIN of 6 volts, a bias current IB1 of 2 microamperes, and a mirror current IM1 of 8 microamperes, the control voltage NGSW generated at the first end of the transistor MN4 is, for example, 5.3 volts.

In the first duty cycle DP1, the switch SW1 may be turned on based on the control voltage NGSW received at the control end. Correspondingly, the mirror current IM1 may flow through the switch SW1 to charge the capacitor CG, thereby elevating the control voltage NG at the control end of the transistor MDNBT to a voltage value (for example, equal to 3.9 volts). Accordingly, the transistor MDNBT may be fully turned on.

Please note that, based on the conductive state of the switch SW1, the voltage NGPRE at the coupling end of the diode string 220 and the switch SW1 is substantially equivalent to 3.9 volts.

Moreover, in the first duty cycle DP1, the control voltage NG has a relatively low voltage value, and consequently the output voltage VBT has a relatively low voltage value, for instance, equal to 4.3 volts.

In the second duty cycle DP2, the reference voltage VLX on the reference voltage end LX is elevated to substantially equal the input voltage VIN due to the conduction of the high-side power transistor of the voltage converter corresponding to the bootstrap control circuit 500. Correspondingly, the diode of the base of the transistor MP2 may be turned on under the circumstances, thereby clamping the control voltage NGSW to a voltage value, for example, equal to 6 volts. During this period, the voltage value of the control voltage NGSW is not greater than the voltage value of the input voltage VIN.

Whereas the base of the transistor MN4 is coupled to the reference voltage end LX, the voltage NGPRE shall not conduct to the control voltage NGSW through the diode of the base of the transistor MN4. Therefore, the voltage NGPRE may be higher than the input voltage VIN, for instance, equal to 9.2 volts. Furthermore, the voltage difference between the control end (gate) and the first end (source) of the transistor MSW (which is equal to the control voltage NGSW minus the voltage NGPRE) is less than 0, thus, the transistor MSW is cut off, and the switch SW1 is turned off.

At this juncture, since a voltage difference between two ends of the capacitor CB is constant, the output voltage VBT may equal to the reference voltage VLX adding the voltage difference between two ends of the capacitor CB when the referential voltage VLX is pulled up to the voltage VIN, where the output voltage VBT may equal to, for example, 10.3 volts.

Pursuant to the switch SW1 in an off state, the potential leakage path of the capacitor CG may be effectively cut off. Under such circumstances, the voltage value of the control voltage NG may be efficaciously maintained without deterioration for a relatively extended duration. Correspondingly, the output voltage VBT generated by the transistor MDNBT may be effectively sustained at a comparatively elevated voltage level.

It is noteworthy that the numerical values of the multiple voltage levels mentioned in the aforementioned embodiment are provided for the purpose of facilitating the explanation of the operational details of the bootstrap control circuit 200 in the embodiments of the present disclosure. These values do not indicate that the bootstrap control circuit 200 in the embodiments of the present disclosure is required to operate at these specific voltage levels. The designer may, based on the actual circuit requirements, configure the parameters of various circuit components and generate corresponding voltage values accordingly.

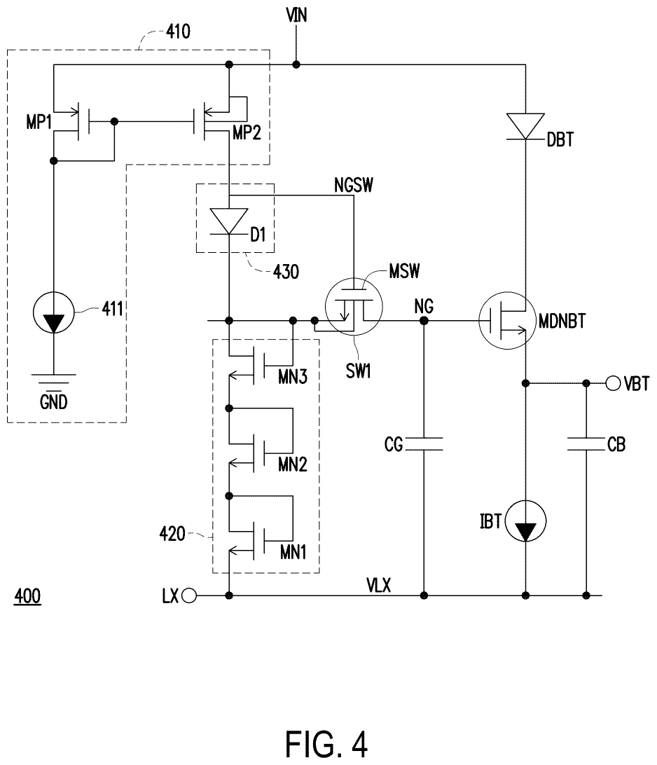

Please refer to FIG. 4, FIG. 4 illustrates a schematic diagram of a bootstrap control circuit according to yet another embodiment of the present disclosure. The bootstrap control circuit 400 includes a current mirror 410, a diode string 420, a control voltage generator 430, a switch SW1, a transistor MDNBT, a diode DBT, a capacitor CB, and a current source IBT. In this embodiment, the current mirror 410 includes a current source 411 and transistors MP1 and MP2. The diode string 420 is connected to transistors MN1 to MN3 in series.

The present embodiment differs from the embodiment illustrated in FIG. 2 in that the control voltage generator 430 of the present embodiment is constructed using a diode D1. Specifically, the anode of the diode D1 is coupled to the second end of the transistor MP2 within the current mirror 420, while the cathode of the diode D1 is coupled to the first end of the switch SW1.

The operational details of the bootstrap control circuit 400 are similar to those of the aforementioned bootstrap control circuit 200, and therefore will not be elaborated upon herein.

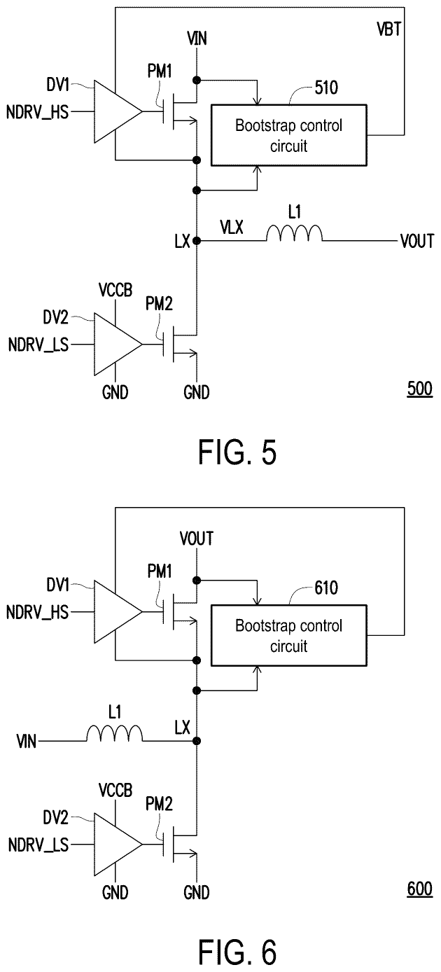

Please refer to FIG. 5, FIG. 5 illustrates a schematic diagram of a voltage converting device according to an embodiment of the present disclosure. The voltage converting device 500 includes power transistors PM1 and PM2, drivers DV1 and DV2, an inductor L1, and a bootstrap control circuit 510. The power transistors PM1 and PM2 are connected in series between an input voltage VIN and a reference ground voltage GND. The drivers DV1 and DV2 are high-side and low-side drivers, respectively, and are configured to drive the power transistors PM1 and PM2, respectively.

The bootstrap control circuit 510 is coupled to the two ends of the power transistor PM1. One end of the bootstrap control circuit 510 receives the input voltage VIN, while the other end of the bootstrap control circuit 510 is coupled to the reference voltage end LX. One end of the inductor L1 is coupled to the reference voltage end LX, and the other end of the inductor L1 is configured to generate the output voltage VOUT.

The bootstrap control circuit 510 may be implemented using the aforementioned bootstrap control circuit 100, 200, or 400 of the preceding embodiments. The output voltage VBT generated by the bootstrap control circuit 510 may be supplied to the driver DV1 and serve as the power supply voltage for the driver DV1.

The drivers DV1 and DV2 respectively receive drive control signals NDRV_HS and NDRV_LS, and generate drive signals based on the drive control signals NDRV_HS and NDRV_LS, respectively, to drive the power transistors PM1 and PM2, respectively. In the present embodiment, the driver DV1 may receive a reference voltage VLX on the reference voltage end LX to serve as a reference ground voltage. The driver DV2 may receive the voltage VCCB as a power supply voltage, while the ground end may receive the reference ground voltage GND.

Based on the waveform diagram illustrated in FIG. 3, in the present embodiment of the disclosure, the bootstrap control circuit 510 may utilize the configured switch (such as switch SW1 in FIG. 2) to generate an output voltage VBT with a relatively high voltage value. Consequently, the driver DV1 may provide a driving signal with a relatively high voltage value to drive the power transistor PM1, thereby effectively reducing the on-state resistance of the power transistor PM1.

It should be noted that, in the present embodiment, the voltage converting device 500 is a step-down voltage converter.

Please refer to FIG. 6, FIG. 6 illustrates a schematic diagram of a voltage converting device according to still another embodiment of the present disclosure. The voltage converting device 600 includes power transistors PM1 and PM2, drivers DV1 and DV2, an inductor L1, and a bootstrap control circuit 610. The power transistors PM1 and PM2 are connected in series, with one end of the power transistor PM1 generating the output voltage VOUT, and one end of the power transistor PM2 coupled to the reference ground voltage GND. The drivers DV1 and DV2 are high-side and low-side drivers, respectively, configured to drive the power transistors PM1 and PM2.

The bootstrap control circuit 610 is coupled to the two ends of the power transistor PM1. One end of the bootstrap control circuit 610 receives the output voltage VOUT, while the other end of the bootstrap control circuit 610 is coupled to the reference voltage end LX. One end of the inductor L1 is coupled to the reference voltage end LX, and the other end of the inductor L1 is configured to receive the input voltage VIN.

The bootstrap control circuit 610, by interchanging the positions of the input voltage VIN and the output voltage VOUT, may be implemented using the bootstrap control circuits 100, 200, or 400 in the aforementioned embodiments. Similar to the embodiment in FIG. 5, the output voltage VBT generated by the bootstrap control circuit 610 may be supplied to the driver DV1 and serve as the power supply voltage for the driver DV1.

It should be noted that, in the present embodiment, the voltage converting device 600 is a step-up voltage converter.

Based on the foregoing, the bootstrap control circuit of the present disclosure may be positioned between the control end of the transistor generating the output voltage and the current mirror, and the control voltage generator may be used to regulate the on or off state of the switch based on the voltage at the reference voltage end. In this way, particularly when the voltage converting device operates under high duty ratio conditions (for example, greater than or equal to 90%), when the switch is turned on, the capacitor on the control end of the transistor may rapidly charge to elevate the control voltage; when the switch is turned off, the leakage path on the control end of the transistor may be cut off, allowing the control voltage to maintain a constant voltage value, thereby ensuring the normal operation of the bootstrap control circuit.

What is claimed is:

1. A bootstrap control circuit, comprising:
a current mirror, based on an input voltage, mirroring a bias current to generate a mirror current;
a diode string, coupled between the current mirror and a reference voltage end;
a switch, having a first end coupled to the diode string, a control end of the switch receiving a first control voltage, and a second end of the switch providing a second control voltage;
a control voltage generator, generating the first control voltage corresponding to a voltage on the reference voltage end; and
a first transistor, based on the input voltage, generating an output voltage according to the second control voltage.

2. The bootstrap control circuit according to claim 1, wherein the control voltage generator comprises:
a first diode, having a first end coupled to the current mirror to receive the mirror current, and configured to provide the first control voltage, wherein a second end of the first diode is coupled to the first end of the switch.

3. The bootstrap control circuit according to claim 1, further comprising:
a capacitor, coupled between a control end of the first transistor and the reference voltage end.

4. The bootstrap control circuit according to claim 3, wherein in a first duty cycle, the switch is turned on, and the capacitor receives the bias current through the switch to charge, causing the second control voltage to be elevated to a first voltage value.

5. The bootstrap control circuit according to claim 4, wherein in the first duty cycle, the voltage on the reference voltage end is a reference ground voltage.

6. The bootstrap control circuit according to claim 5, wherein in a second duty cycle, the voltage on the reference voltage end is equal to the input voltage, and the switch is turned off to cut off a discharge path between the control end of the first transistor and a second end of a first diode.

7. The bootstrap control circuit according to claim 6, wherein the current mirror comprises:
a second transistor, having a first end to receive the input voltage, a second end of the second transistor receiving the bias current, a control end of the second transistor being mutually coupled with the second end of the second transistor; and
a third transistor, having a first end to receive the input voltage, a second end of the third transistor generating the mirror current, a control end of the third transistor coupled to the control end of the second transistor, a base of the third transistor coupled to the first end of the third transistor.

8. The bootstrap control circuit according to claim 7, wherein in the second duty cycle, a diode of the base of the third transistor is turned on, causing the first control voltage to be clamped to a second voltage value, wherein the second voltage value is not greater than a voltage value of the input voltage.

9. The bootstrap control circuit according to claim 2, wherein the switch comprises a second transistor, wherein a first end of the second transistor is coupled to a second end of the first diode, a second end of the second transistor is coupled to a control end of the first transistor, a control end of the second transistor receives the first control voltage, and a base of the second transistor is coupled to the first end of the second transistor.

10. The bootstrap control circuit according to claim 2, wherein the first diode is constructed by a second transistor, wherein a first end of the second transistor is coupled to the current mirror, a second end of the second transistor is coupled to the first end of the switch, a control end of the second transistor receives the first control voltage, and a base of the second transistor is coupled to the reference voltage end.

11. The bootstrap control circuit according to claim 2, wherein an anode of the first diode is coupled to the current mirror, and a cathode of the first diode is coupled to the first end of the switch.

12. The bootstrap control circuit according to claim 2, further comprising:
a second diode, having an anode end to receive the input voltage, and a cathode end of the second diode coupled to a first end of the first transistor;
a current source, coupled between a second end of the first transistor and the reference voltage end; and
a voltage stabilizing capacitor, connected between the second end of the first transistor and the reference voltage end.

13. A voltage converting device, comprising:
a first power transistor and a second power transistor, connected in series between an input voltage and a reference ground voltage, or connected in series between an output voltage and the reference ground voltage;
a first driver and a second driver, respectively configured to drive the first power transistor and the second power transistor;
an inductor, coupled between a mutual coupling end of the first power transistor and the second power transistor and an output end or an input end of the voltage converting device; and
the bootstrap control circuit according to claim 1, coupled between two ends of the first power transistor.

14. The voltage converting device according to claim 13, wherein when the first power transistor is coupled to the input voltage and the inductor is coupled to the output end of the voltage converting device, the voltage converting device is a step-down voltage converting device; when the first power transistor is coupled to the output voltage and the inductor is coupled to the input end of the voltage converting device, the voltage converting device is a step-up voltage converting device.

15. The voltage converting device according to claim 13, wherein the output voltage generated by the bootstrap control circuit is provided as a power supply voltage for the first driver.

16. The voltage converting device according to claim 13, wherein a duty ratio of a power switching operation of the voltage converting device is greater than a threshold.

17. The voltage converting device according to claim 13, wherein the first power transistor and the second power transistor are both N-type transistors.
